(19) United States
(12) Patent Application Publication
(10) Pub. No.: US 2011/0234636 A1
(43) Pub. Date: Sep. 29, 2011

(54) METHOD AND INTEGRATED CIRCUIT FOR IMAGE MANIPULATION

(75) Inventors: Yuval Itkin, Zoran (IL); Yaron Bercovitz, Holon (IL)

(73) Assignee: DSP Group Ltd., Herzelia (IL)

(21) Appl. No.: 12/730,268

(22) Filed: Mar. 24, 2010

(51) Int. Cl. G09G 5/00; G09G 5/36

(52) U.S. Cl. 345/649; 345/545

(57) ABSTRACT

A method and integrated circuit for manipulating two dimensional images. The method and integrated circuit use an on-chip memory buffer comprising four memory elements, and accessed as a rectangle of 4 times an integer number of bytes by a number of lines depending on the image resolution.

Each block of the source image is copied from the DRAM into the on-chip memory buffer, and a destination block is determined within the destination image. The destination block is populated by determining the addresses within the on-chip memory buffer comprising the pixels to be copied to the relevant location in the destination block, reading the data from the on-chip memory buffer, and writing it to the destination block. In some embodiments the data may be multiplexed, or bytes may be re-ordered within the read data prior to writing.

### TECHNICAL FIELD

The present disclosure relates to image processing in general, and to an integrated circuit and method for efficiently performing operations such as flipping or rotating on two dimensional images, in particular.

### BACKGROUND

In recent years, digital photography and image processing have revolutionized aspects of everyday lives. Digital cameras and image processing tools have become part of everyday life of many people worldwide. With the decreased memory prices and increased resolution and capacity, more and larger images are being captured and processed.

Processing large images presents heavy requirements on the processing system, including storage, memory, CPU and bus.

In particular, when performing operations on large images, the time periods required for reading and writing to and from the Dynamic Random Access Memory (DRAM) on which the images are stored, constitute a significant portion of the overall time required for the operation. This ratio between the DRAM read/write times and the total handling time is particularly high when performing simple operations which do not involve complex computations, such as flip or rotate.

There is thus a need for an integrated circuit and method for providing DRAM-efficient operations on digital images.

### SUMMARY

A method and integrated circuit for performing image manipulations by making efficient usage of the bandwidth of a Dynamic Random Access Memory (DRAM) on which the image is stored.

A first aspect of the disclosure relates to a method for manipulating an image stored in a source location and obtaining a manipulated image in a destination location, comprising: determining a block size in accordance with a characteristic of the image; and for each block within the source image, manipulating the block, comprising: copying the block from the source location to an on-chip memory buffer, comprising a predetermined number of memory elements arranged as a rectangle having a rectangle width in bytes being a multiple of 4 times an integer number equal to or larger than one; determining a destination block location for the block; and for an address sequence within the destination block location, performing: determining one or more addresses within the memory buffer which contain pixels to be written at the address sequence within the destination block location; reading data from the one or more addresses within the memory buffer; and writing the data in the address sequence within the destination block. The method can further comprise multiplexing the data read from the one or more addresses within the memory buffer. The method can further comprise changing byte order within the data read from the one or more addresses within the memory buffer. Within the method, the manipulation is optionally flipping or rotating. Within the method, the on-chip memory buffer optionally comprises four memory elements of four times the integer number squared bytes each. Within the method, the number of lines in the block is optionally determined as the rectangle width divided by the number of bytes per pixel in the image. Within the method, the block width is optionally 64 bytes. Within the method, the on-chip memory buffer optionally comprises four memory elements of one kilo byte each.

Another aspect of the disclosure relates to a method for manipulating an image stored in a source location and obtaining a manipulated image in a destination location, comprising: determining a block size in accordance with a characteristic of the image; for each block within the image, manipulating the block, comprising: determining a destination block location for the block; for an address sequence within the destination block location, performing: determining one or more addresses within the source image which contain pixels to be written at the address sequence within the destination block location; copying information from the source location to an on-chip memory buffer, comprising a predetermined number of memory elements arranged as a rectangle having a width being a multiple of four times an integer number equal to or larger than one, in a location corresponding to the address sequence; reading data from the on-chip memory buffer; and writing the data in the address sequence within the destination block location.

Yet another aspect of the disclosure relates to an integrated circuit for manipulating an image stored in a source location on a dynamic random access memory (DRAM) for obtaining a manipulated image in a destination location on the DRAM, comprising: on-chip memory buffers comprising a predetermined number of memory elements, the on-chip memory buffer adapted to comprise a block of data from the image; an address generator for determining one or more addresses within the on-chip memory buffer which contain pixels to be written at an address sequence within a destination location for the block of data; a controller for controlling the operation and data flow within the integrated circuit and between the integrated circuit and the DRAM; and a bus for transferring data between the integrated circuit and the DRAM. The integrated circuit can further comprise one or more multiplexers for multiplexing data read from the on-chip memory buffer. Within the integrated circuit, the manipulation is optionally flipping or rotating. Within the integrated circuit, the on-chip memory buffer optionally comprises a predetermined number of memory elements, arranged as four memory banks. Within the integrated circuit, the on-chip memory buffer optionally comprises a predetermined number of memory elements, each having a size in bytes of four times an integer number squared. Within the integrated circuit, the block optionally has a width in bytes of a multiple of four by the integer number, and the block has a number of lines determined as the block width in bits divided by the number of bits per pixel in the image. Within the integrated circuit, the on-chip memory buffer optionally comprises four memory elements having a size in bytes of four times the integer number squared each. Within the integrated circuit, the block width is optionally 64 bytes.

### DESCRIPTION OF THE DRAWINGS

The present disclosure will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a block diagram of the main components in a system for image processing, in accordance with the disclosure;

FIG. 2 is a schematic illustration of an on-chip memory buffer used for performing operations on images, in accordance with the disclosure;

FIG. 3 is a schematic illustration of the read or write operations for rotating an 8 bit-per-pixel image in 90°, in accordance with the disclosure;

FIG. 4 is a schematic illustration of the multiplexing performed when rotating an 8 bit-per-pixel image in 90°, in accordance with the disclosure;

FIG. 5 is a schematic illustration of the read or write operations for rotating a 16 bit-per-pixel image in 90°, in accordance with the disclosure;

FIG. 6 is a schematic illustration of the multiplexing performed when rotating a 16 bit-per-pixel image in 90°, in accordance with the disclosure;

FIG. 7 is a schematic illustration of the read or write operations for rotating a 32 bit-per-pixel image in 90°, in accordance with the disclosure;

FIG. 8 is a schematic illustration of the multiplexing performed when rotating a 32 bit-per-pixel image in 90°, in accordance with the disclosure;

FIG. 9 is a schematic illustration of the read or write operations for rotating a 32 bit-per-pixel image in 180°, in accordance with the disclosure;

FIG. 10 is a schematic illustration of the read or write operations for rotating a 16 bit-per-pixel image in 180°, in accordance with the disclosure;

FIG. 11 is a schematic illustration of the read or write operations for rotating an 8 bit-per-pixel image in 180°, in accordance with the disclosure;

FIG. 12 is a schematic illustration of the read or write operations for flipping an image, in accordance with the disclosure; and

FIG. 13 is a flowchart of the main steps in manipulating images, in accordance with the disclosure.

### DETAILED DESCRIPTION

The disclosed method and integrated circuit provide for performing operations on a digital image in an efficient manner, and particularly by making efficient usage of the bandwidth of the Dynamic Random Access Memory (DRAM) on which the image is stored.

The disclosed method and apparatus are particularly useful for operations in which the order of the pixels within an image is manipulated, such as flip or rotate. Such operations generate from an image stored in the DRAM on a source location, a manipulated, e.g., flipped or rotated image stored in a destination location.

The method and integrated circuit use an on-chip memory buffer of a predetermined size, such as a multiple of four of a square integer number, for example 4 KB, into which blocks of the image are copied, processed, and copied back to the DRAM. In some embodiments the integer number is 16. The buffer is logically arranged as a predetermined number of banks, such as four memory elements of a size being four times the integer number squared, such as 1 KB, or 1K×8 bit each. When the buffer is 4 KB large, it contains four (4) elements of 1 KB each. The integrated circuit also uses a smart address generator and multiplexer.

Using 4 KB blocks addresses the limitations of the DRAM access restrictions, and thus reduces the overhead of accessing the DRAM. In addition, adding a 4 KB buffer to a chip does not require significant resources, so the solution is relatively cheap and cost-effective.

The image to be operated on is partitioned into rectangles or blocks having a width of four times the integer number of bytes, such as 64 bytes, times N lines or rows. N is determined as the block width, such as 64, divided by the number of bytes required for each pixel (a Byte equals 8 bits). For example, for a 4 KB buffer, and wherein each pixel in the image is represented by 8 bit, i.e., 8 bit per pixel (8 bpp), the buffer will contain 64 lines of 64 bytes each. For a 16 bpp image the buffer will contain 32 lines, and for a 32 bpp image the buffer will contain 16 lines.

This arrangement of the buffer allows for reading from the DRAM a contiguous block of N lines of 64 B at N transactions, which is an efficient way to access DRAM memory. Each block is thus read from the DRAM and stored in the buffer, and then read from the buffer in the required order, e.g., flipped or rotated as described below, and written to the correct block location within the destination on the DRAM also as contiguous N lines of 64 B, thus utilizing well the DRAM bandwidth.

In an alternative embodiment, the operation such as flipping or rotating can be performed upon storing the image block into the buffer. Thus, the image block is not copies to the buffer but rather its content is manipulated. The storing is then followed by reading and copying from the buffer to the destination image without further manipulations.

It will be appreciated that in addition to operating on every block, the order of the blocks within the image has to change, i.e., a block in the source image may is have to be written to a different location in the destination image. The block ordering, i.e., the relation between the location of the read and the written blocks depends on the particular operation.

Thus, the operation is hierarchical in that each block may be moved to another location according to the operation, while its content is also manipulated in accordance with the same operation.

For some image operations such as flipping and rotating, the manipulations within each block are orthogonal to the manipulations within other blocks, and also orthogonal to the inter-block ordering, so that each block can be handled in the same manner but separately, without inter-block influence.

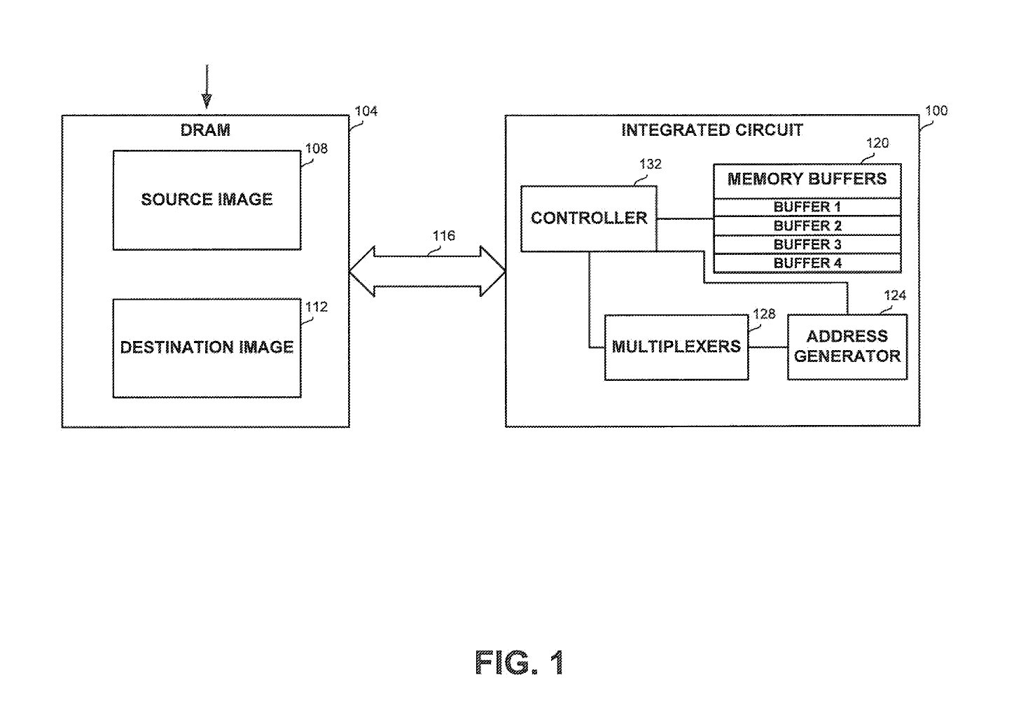

Referring now to FIG. 1, showing a block diagram of the main components in a system for image processing, in accordance with the disclosure. The shown components are those that are added to an integrated circuit in order for an ordinary processing system to enable the current method. Thus, FIG. 1 does not comprise components such as Central Processing Unit (CPU), power supply, clock controller, Input-Output (IO) control, system integration modules such as interrupt controllers and cache as well as embedded memory and others.

The system uses integrated circuit 100, to manipulate source image 108 residing on DRAM 104 into destination image 112. DRAM 104 communicates with integrated circuit 100 via bus 116.

Integrated circuit 100 comprises memory buffers 120, which in some embodiments comprise a predetermined number of memory elements of capacity 1 KB each. In some embodiments memory buffers 120 comprise four memory buffers, so that the total capacity is 4 KB. Integrated circuit 100 further comprises address generator 124 which generates the addresses to be accessed within memory buffers 120 from the coordinates in destination 112 which are being written.

Integrated circuit 100 further comprises multiplexers 128 for multiplexing the data read from memory buffers 120 and controller 132 to control the data and operation flow within integrated circuit 100 and between integrated circuit 100 and DRAM 104.

It will be appreciated that the disclosed components can be implemented as hardware, software, or firmware components. In particular, the image operations may be implemented as a stand-alone hardware, as an integral part of a DMA engine or any processing element with DMA capability.

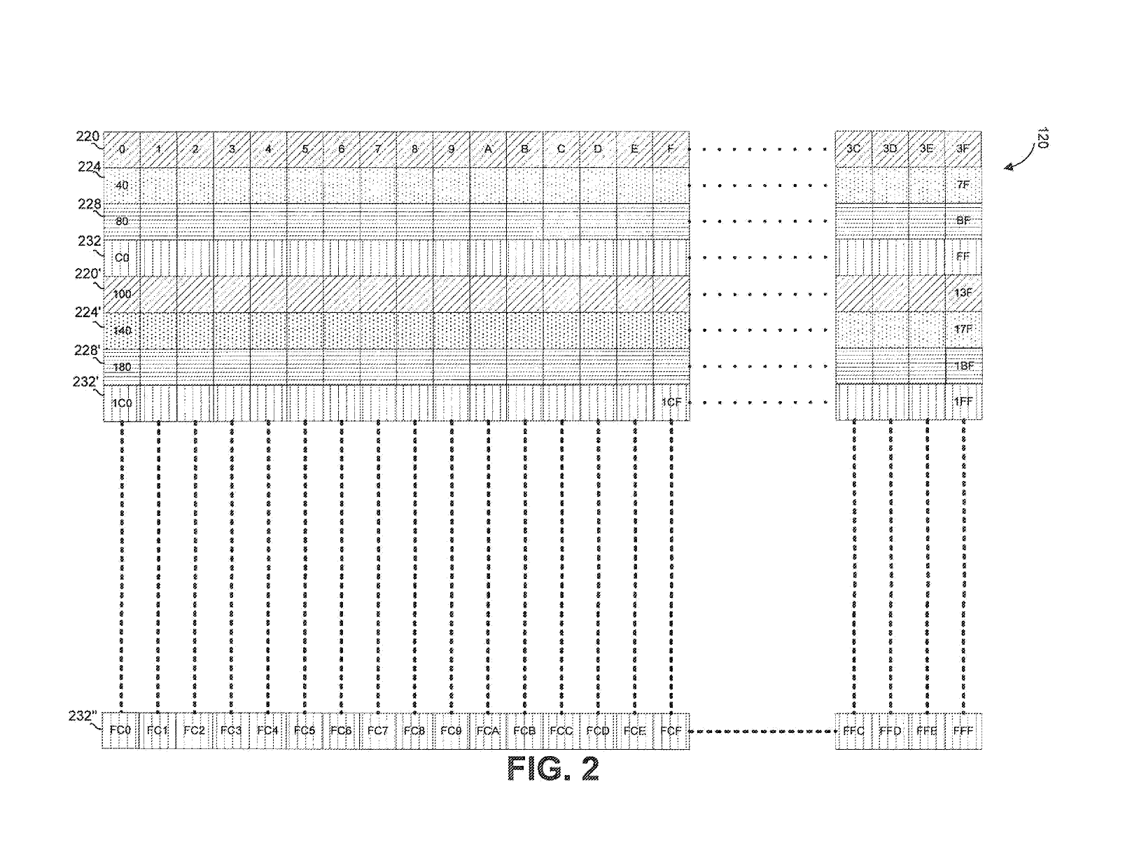

Referring now to FIG. 2-FIG. 12 describing the various configurations and options for rotating and flipping images. As image rotation and flipping mandates efficient access to multiple bytes stored in multiple locations in the memory map, special hardware (HW) is used to allow bandwidth and cycle-efficient image rotation and flipping. The rotation uses 1 Direct Memory Access (DMA) channel in order to rotate the image using embedded 1 KB square boxed buffer inside the DMA control hardware. The DMA controller uses descriptors or registers to configure the DMA transfer channels. The descriptor pointers for the rotation operations are interpreted differently than for the other transfer modes. Since this special mode is using a single memory buffer embedded inside the DMA hardware, no more than a single DMA channel can be used for image rotation at any given time, even if the DMA controller is multi-channel, as channels transfers are interleaved.

The disclosed solution hardware enables flipping and rotation for 8 bpp, 16 bpp and 32 bpp, thus allowing support for all popular image and video storage formats.

Referring now to FIG. 2, showing the configuration, i.e., the memory structure and addressing of on-chip memory 120, as used for operating on an 8 bpp image. As detailed above, in some embodiments the memory comprises 4 elements of 1 KB each. The memory is addressed as 64 lines of 64 B each, wherein the lines belonging to the four elements are interleaved. Thus, in FIG. 2, lines 220 and 220′ which are indicated by a diagonal pattern, as well as further lines not shown in the figure belong to the first element; lines 224 and 224′ which are indicated by a dotted pattern, as well as further lines not shown in the figure belong to the second is element; lines 228 and 228′ which are indicated by horizontal stripes, as well as further lines not shown in the figure belong to the third element; and lines 232, 232′ and 232″, which are indicated by vertical stripes, as well as further lines not shown in the figure belong to the fourth element.

In this arrangement, each pixel takes a single byte, and is graphically described as a single square within the buffer, with its address in the 8 bpp configuration indicated.

Since reading data from the 2D buffer is done in 32 bit units, no byte write access to the buffer elements is required.

When manipulating 16 bpp or 32 bpp images, the same memory elements are used. However, since each pixel takes up two or four bytes, the memory elements are mapped as having fewer lines than in the 8 bpp case. Thus, four 1 KB elements provide 64 lines for an 8 bpp image, 32 lines for a 16 bpp image, and 16 lines for 32 bpp image, in order to maintain a structure of M pixels×M lines. Thus, in some embodiments, not all the memory entries are in actual use when manipulating so 16 bpp or 32 bpp images.

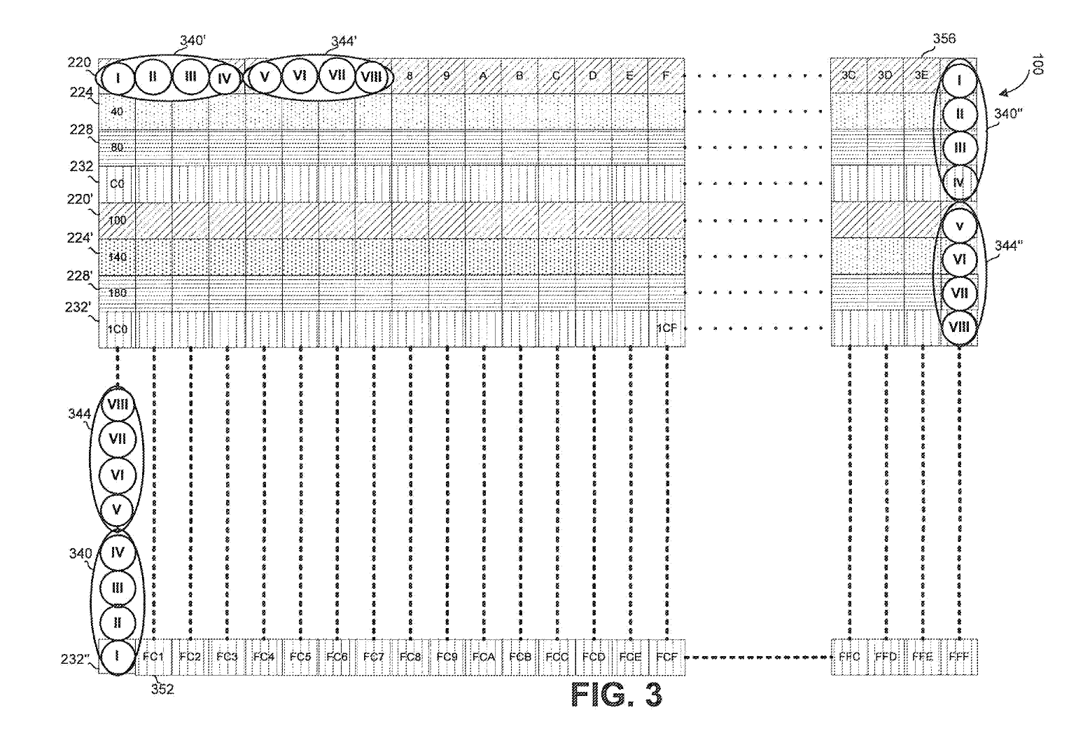

Referring now to FIGS. 3-8, showing a schematic illustration of the read or write operations for rotating an image in 90°.

For all image resolutions, the image blocks are scanned according to the destination image raster-scan order (left to right within each line, and top to bottom). The source blocks coordinates are determined from the destination block coordinates. When rotating an image in 90°, a block in the [X,Y] source coordinates is written to the destination location in the following coordinates:

when rotating an image in the clockwise direction,

Xsource=Ydestination

Ysource=(source_image_y_size/box_height)−Xdestination−1

and when rotating an image in the counterclockwise direction,

Xsource=(source_image_x_size/box_height)−Ydestinbation−1

Ysource=Xdestination

Wherein Xsource and Ysource are the X and Y coordinates of the block within the source image, and Xdestination and Ydestination are the coordinates of the block to which the source block is transferred in the rotated image.

Referring now to FIG. 3, showing a schematic illustration of the read or write operations for rotating a block of an 8 bpp image in 90°.

FIG. 3 describes an embodiment in which the image block is stored in the buffer as is, and the operation is performed while reading from the buffer to the destination location. However, the same principle can be used in order to perform the operation while writing to the buffer, and reading the information from the buffer as is.

It will be appreciated that in order to generate a clockwise 90° rotation, the bottom left pixel should move to the top left pixel, pixel 352 to its right should be moved to the leftmost pixel of line 224, and so on.

Reading data to and from the buffer is done in 32 bit units, i.e., 4 pixels at a time in the configuration of FIG. 3. Therefore, when reading the data from the buffer in order to write it to the destination location at the DRAM as rotated, the four pixels surrounded by ellipse 340 are read and written to location 340′. This read operation extracts data from the four memory elements at once, which demonstrates the importance of the address arrangement.

Next, the four pixels surrounded by ellipse 344 are read and written to location 344′, and so on. Once all pixels of the top line are written at the destination, the pixels of the line 224 are written. Thus, in order to fill the destination from left to right and from top to bottom, the buffer is read bottom to top and left to right.

If a rotation of 90° in the counter clock wise direction is required, then in order to fill the destination from left to right and from top to bottom, the buffer is read top to bottom and right to left. Thus, the pixels surrounded by ellipse 340″ are written in location 340′, the pixels surrounded by ellipse 344″ are written in location 340′, and so on. When the top line of the destination is fully written, the pixels at column 356 are read and written, and so on.

It will be appreciated that since each 32 bit block relates to four pixels, the order of the pixels is different, as indicated by the numbers of the circles within the ellipses.

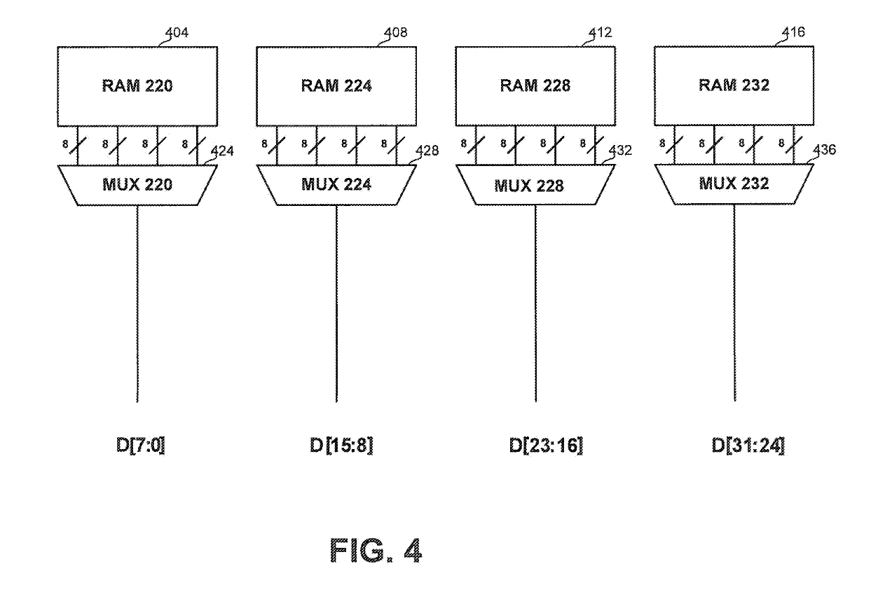

Referring now to FIG. 4, showing the read data path of the rotated image for 90° rotation of a block of an 8 bpp image.

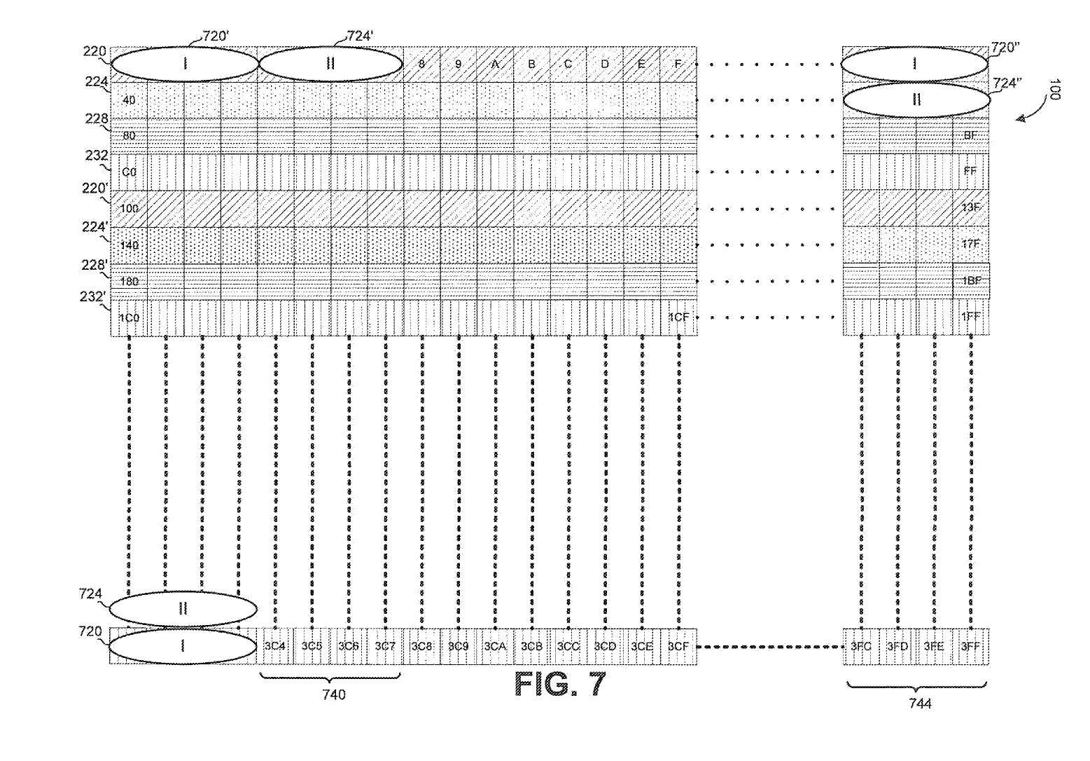

As detailed in association with FIG. 7 below, when rotating a 32 bpp image, 32 consecutive bits are read from each buffer at a single read operation. Since the same four memory elements are used for manipulating images of all bpp resolutions, additional read data paths in which 32 bits are read from each of the 4 memory buffers, and a selecting MUX for selecting the read data from the 4 simultaneous readings of the 4 memories is used to read data from the buffer. Thus, 32 bits are read from each RAM, represented as multiple lines in FIG. 2: RAM 220 (404) comprises lines 220, 220′ and further lines, RAM 224 (408) comprises lines 224 and 224′ and further lines, RAM 228 (412) comprises lines 228, 228′ and further lines, and RAM 232 (416) comprises lines 232, 232, 232″ and further lines. For 8 bpp images, each 32 bits read represent four pixels, and each byte quadruplet received from a memory element is multiplexed by the corresponding multiplexer, such that bytes read from RAM 220 (404) are multiplexed by MUX 220 (424), bytes read from RAM 224 (408) are multiplexed by MUX 224 (428), bytes read from RAM 228 (412) are multiplexed by MUX 228 (432), and bytes read from RAM 232 (416) are multiplexed by MUX 232 (436). The four multiplexers 424, 428, 432 and 436 are commonly controlled, so that corresponding bytes are selected and written to the destination. The other 8 bit channels are selected for writing pixels on the same columns on further lines.

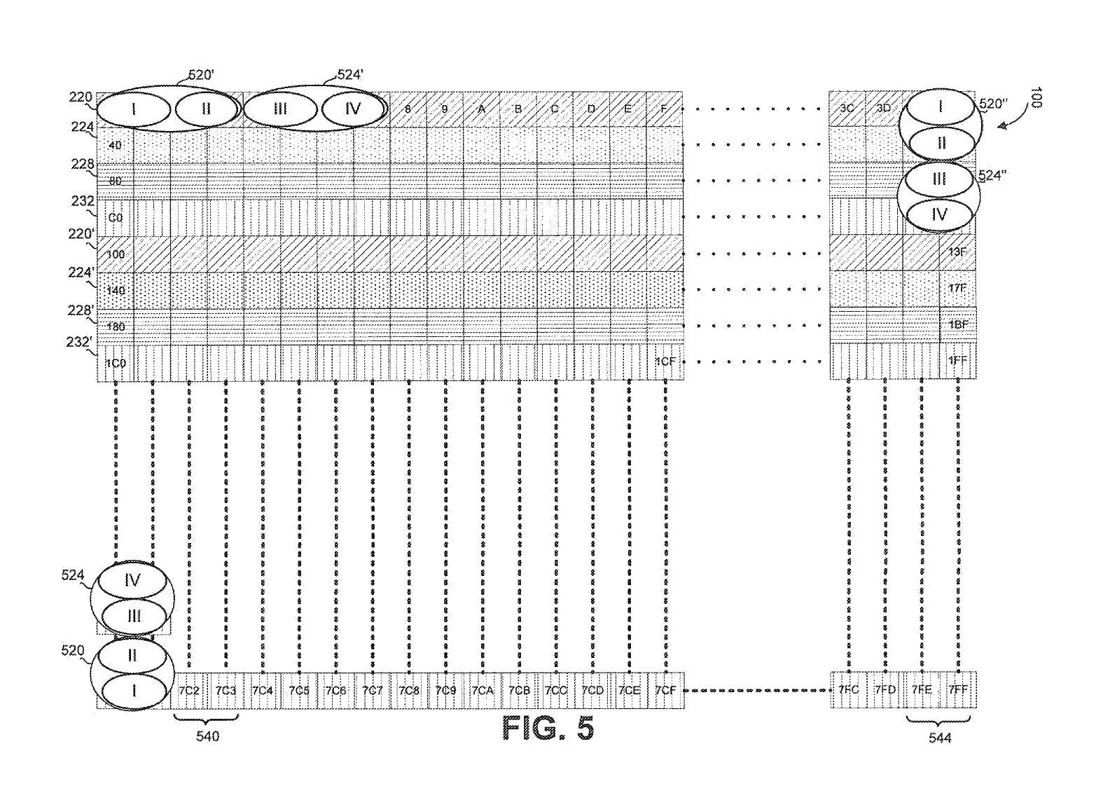

Referring now to FIG. 5, showing a schematic illustration of the read or write operations for rotating a block of a 16 bpp image in 90°.

FIG. 5 describes an embodiment in which the image block is stored in the buffer as is, and the operation is performed while reading from the buffer to the destination location. However, the same principle can be used in order to perform the operation while writing to the buffer, and reading the information from the buffer as is.

It will be appreciated that in order to generate a clockwise 90° rotation, the bottom left pixel, taking up the two leftmost addresses of the bottom line of the buffer should move to the top left pixel and take up the two leftmost addresses there, the pixel above the bottom left pixel should be moved to the second pixel on the left of line 220, and so on.

Reading data to and from the buffer is done in 32 bit units, i.e., 2 pixels at a time in the configuration of FIG. 5. Therefore, when reading the data from the buffer in order to write it to the destination location at the DRAM as rotated, the two pixels surrounded by ellipse 520 are read and written to location 520′. This read operation extracts data from two memory elements at once, which demonstrates the importance of the address arrangement.

Next, the two pixels surrounded by ellipse 524 are read and written to location 524′, and so on. Once all pixels of line 220 are written, the pixels of the next two columns in the buffer, indicated 540, are read and written into line 224. Thus, in order to fill the destination from left to right and from top to bottom, the buffer is read bottom to top and from left to right.

If a rotation of 90° in the counter close wise direction is required, then in order to fill the destination from left to right and from top to bottom, the buffer is read from top to bottom and from right to left. Thus, the pixels surrounded by ellipse 520″ are written in location 520′, the pixels surrounded by ellipse 524″ are written in location 524′, and so on. When the top line of the destination is fully written, the pixels at columns 544 of the buffer are all read.

Although for this configuration two memory elements of 1 KB each may suffice, it is the same system that has to function with all popular resolutions. Therefore, there have to be four memory elements in order to support operating on 8 bpp images, even if in other configurations, such as when manipulating images of 16 bpp and 32 bpp less elements are required.

It will be appreciated that since each 32 bit block relates to two pixels, the order of the pixels is different, as indicated by the numbers of the circles within the ellipses.

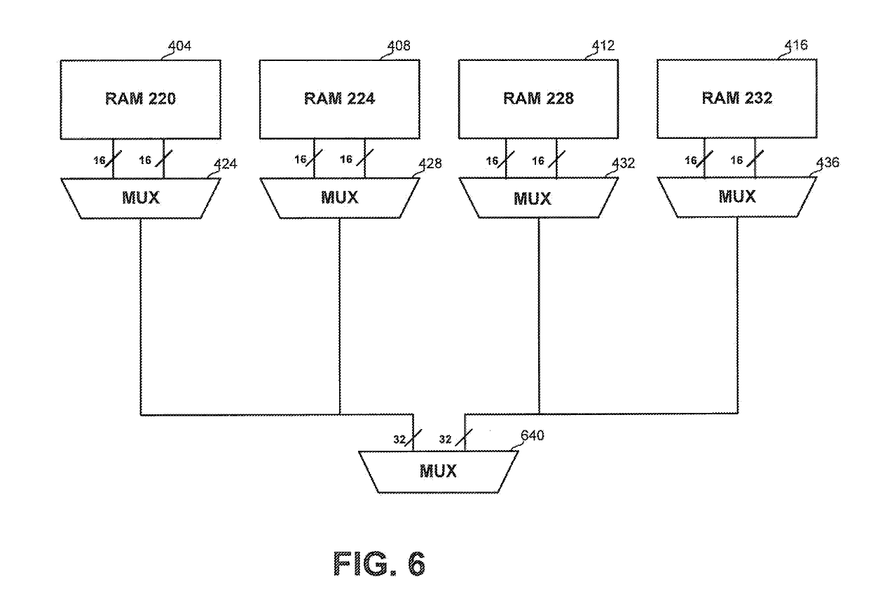

Referring now to FIG. 6, showing the read data path of the rotated image for 90° rotation of a block of a 16 bpp image.

As detailed above, 32 consecutive bits are read from each buffer at a single read operation. For a 16 bpp image, the 32 bits comprise two pixels. Therefore each of multiplexers 424, 428, 432 and 436 receives 2 channels of 16 bits each, and all multiplexers select in a corresponding manner the most significant 16 bits or the least significant 16 bits. The other 16 bit channels are selected for writing further pixels on the same columns on further lines.

It will be appreciated that for 16 bpp images there is a 2-operations-cycle, wherein the first operation reads from the four memory elements. On the second operation the two multiplexed sets of 32 bits are multiplexed again for selecting between the two groups in accordance with the pixels being written.

Referring now to FIG. 7, showing a schematic illustration of the read or write operations for rotating a block of a 32 bpp image in 90°.

FIG. 7 describes an embodiment in which the image block is stored in the buffer as is, and the operation is performed while reading from the buffer to the destination location. However, the same principle can be used in order to perform the operation while writing to the buffer, and reading the information from the buffer as is.

It will be appreciated that in order to generate a clockwise 90° rotation, the bottom left pixel, taking up the four leftmost addresses of the bottom line of the buffer should move to the top left pixel and take up the four leftmost addresses there, the pixel above the bottom left pixel should be moved to the second pixel on the left of line 220, and so on.

Reading data to and from the buffer is done in 32 bit units, i.e. one pixel at a time in the configuration of FIG. 7. Therefore, when reading the data from the buffer in order to write it to the destination location at the DRAM as rotated, the pixel surrounded by ellipse 720 is read and written to location 720′. This read operation extracts data from one memory element.

Next, the pixel surrounded by ellipse 724 is read and written to location is 724, and so on. Once line 220 is fully written, the pixels of the next four columns, indicated 740 are read and written into line 224. Thus, in order to fill the destination from left to right and from top to bottom, the buffer is read bottom to top and left to right.

If a rotation of 90° in the counter close wise direction is required, then in order to fill the destination from left to right and from top to bottom, the buffer is read top to bottom and right to left. Thus, the pixel surrounded by ellipse 720″ is written in location 720′, the pixel surrounded by ellipse 724″ is written in location 724′, and so on. When the top line of the destination is fully written, the pixels at columns 744 are read and written, and so on.

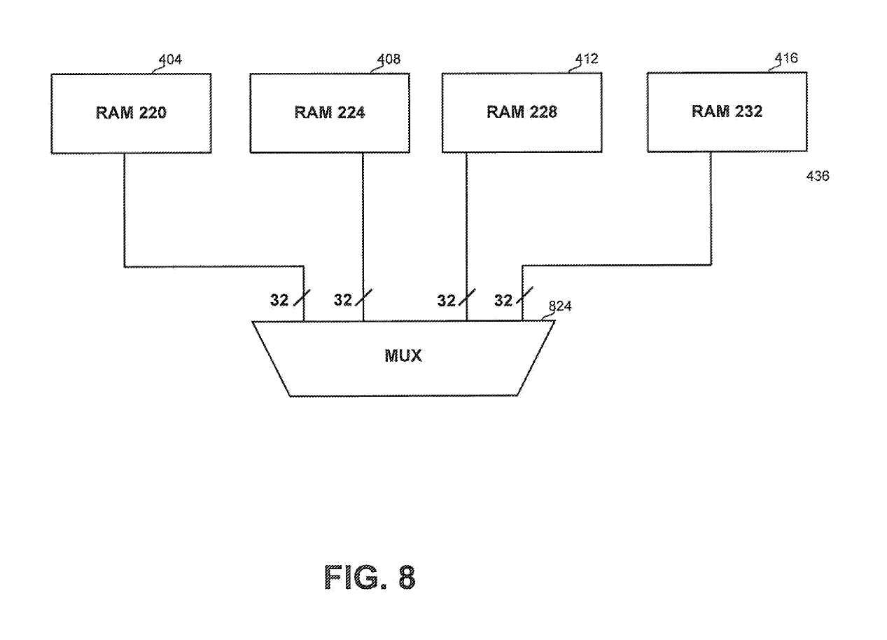

Referring now to FIG. 8, showing the read data path of the rotated image for 90° rotation of a block of a 32 bpp image.

As detailed in association with FIG. 4 above, 32 consecutive bits are read from each buffer at a single read operation. For a 32 bpp image, the 32 bits comprise a single pixel. Therefore multiplexer 824 receives 4 channels of 32 bits each, and selects the bits relevant for the pixel being written. The other channels are selected for writing further pixels.

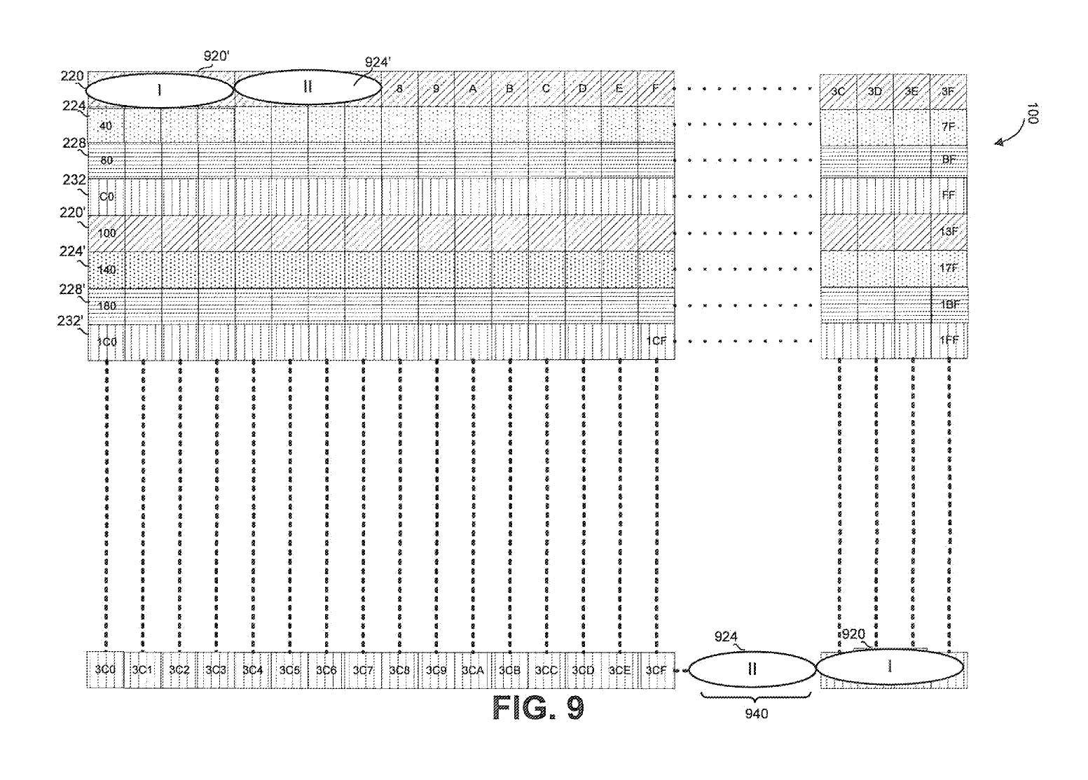

Referring now to FIGS. 9-11, showing a schematic illustration of the read or write operations for rotating an image in 180°.

For all image resolutions, the blocks are scanned according to the destination image raster-scan order (left to right within each line, and top to bottom). When rotating an image in 180°, a block in the [X,Y] source coordinates is written to the destination location in the following coordinates:

Xsource=(image_x_size/block_height)−Xdestination1

Ysource=(image_y_size/block_height)−Ydestination1

Wherein Xsource and Ysource are the X and Y coordinates of the block within the source image, and Xdestination and Ydestination are the coordinates of the block to which the source block is transferred in the rotated image.

Referring now to FIG. 9, showing a schematic illustration of the read or write operations for rotating a block of a 32 bit-per-pixel image in 180°.

FIG. 9 describes an embodiment in which the image block is stored in the buffer as is, and the operation is performed while reading from the buffer to the destination location. However, the same principle can be used in order to perform the operation while writing to the buffer, and reading the information from the buffer as is.

It will be appreciated that in order to generate a 180° rotation, the bottom right pixel, taking up the four rightmost addresses of the bottom line of the buffer should move to the top left pixel and take up the four leftmost addresses of the destination, the pixel above the bottom right pixel should be moved to the leftmost pixel on line 224, and so on.

Reading data to and from the buffer is done in 32 bit units, i.e. one pixel at a time in the configuration of FIG. 9. Therefore, when reading the data from the buffer in order to write it to the destination location at the DRAM as rotated, the pixel surrounded by ellipse 920 is read and written to location 920′. This read operation extracts data from one memory element.

Next, the pixel surrounded by ellipse 924 is read and written to location 924′, and so on. Once all pixels of the top line of the destination are written, the pixels of the second line from the bottom are read and written into the second line of the destination. Thus, in order to fill the destination from left to right and from top to bottom, the buffer is read from right to left and from bottom to top.

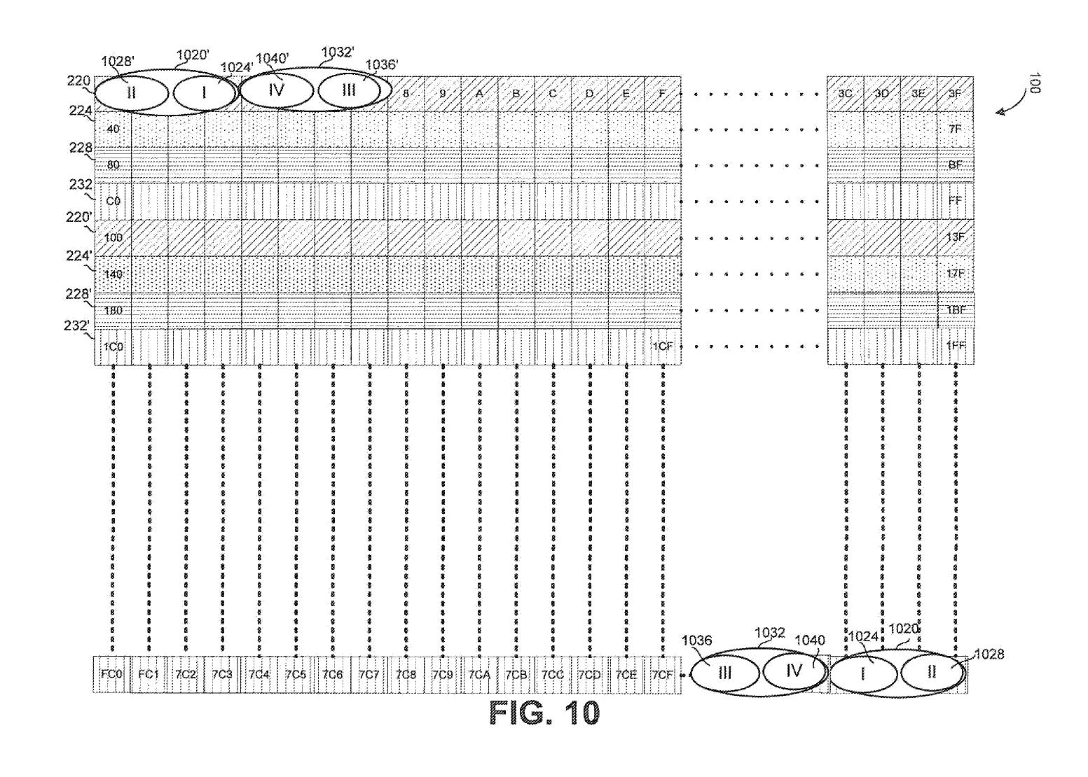

Referring now to FIG. 10, showing a schematic illustration of the read or write operations for rotating a 16 bit-per-pixel image in 180°.

FIG. 10 describes an embodiment in which the image block is stored in the buffer as is, and the operation is performed while reading from the buffer to the destination location. However, the same principle can be used in order to perform the operation while writing to the buffer, and reading the information from the buffer as is.

It will be appreciated that in order to generate a 180° rotation, the two right pixels of the bottom line of the buffer, taking up the four rightmost addresses of the bottom line of the buffer should be moved to the two left pixels of the top line of the destination and take up the four leftmost addresses there, the third and fourth pixels from the right of the bottom line should be copied to the third and fourth pixels from the left of line 220, and so on. However, since each 32 bits sequence represents two pixels, it is required to swap within each read sequence the two most significant bytes (MSB) with the 2 least significant bytes (LSB) when copying the sequence from the buffer to the destination.

Thus, when reading the data from the buffer in order to write it to the destination location at the DRAM as rotated, the two pixels surrounded by ellipse 1020 are read and written to location 1020′, with the two pixels reversed, i.e., pixel 1024 which comprises the MSB is copied to LSB 1024′, and pixel 1028 which comprises the LSB of the sequence is copied to MSB 1028′ at the destination.

Next, the pixels surrounded by ellipse 1032 are read and written to location 1032′, and so on, wherein pixel 1036 which comprises the MSB is copied to LSB 1036′, and pixel 1040 which comprises the LSB of the sequence is copied to MSB 1040′ at the destination.

Once all pixels of the top line of the destination are read, the pixels of the second line from the bottom are read and written into the second line of the destination. Thus, in order to fill the destination from left to right and from top to bottom, the buffer is read from right to left and from bottom to top.

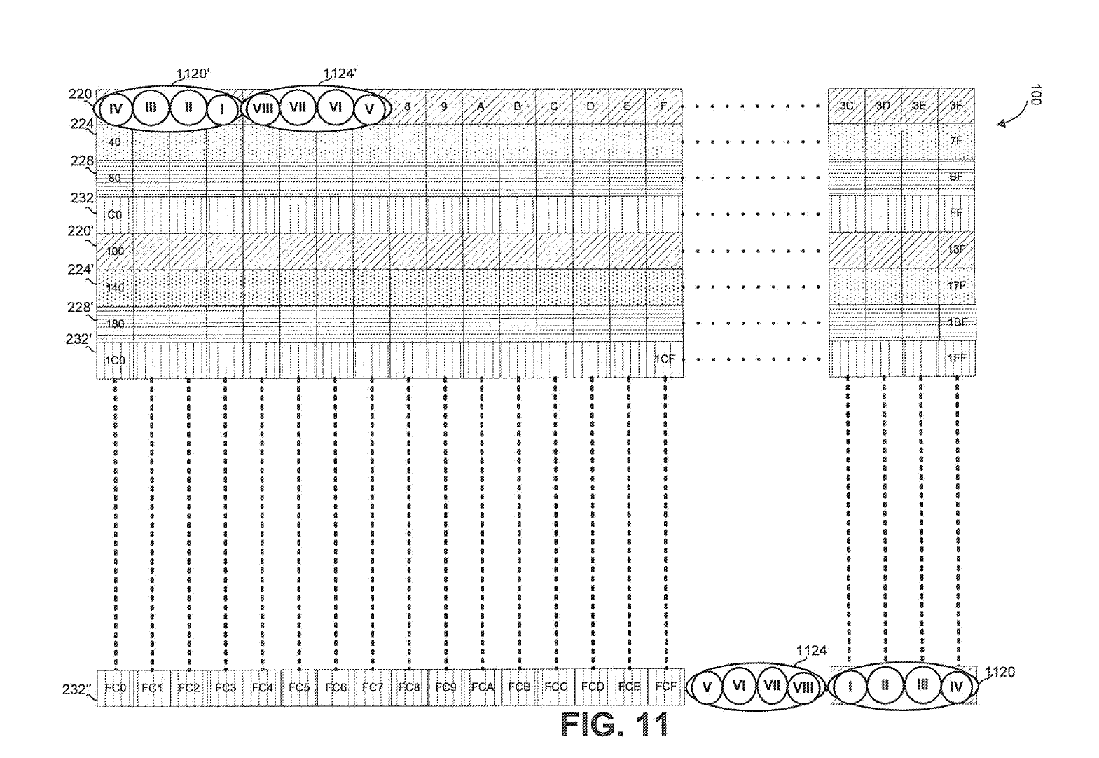

Referring now to FIG. 11, showing a schematic illustration of the read or write operations for rotating an 8 bit-per-pixel image in 180°.

FIG. 11 describes an embodiment in which the image block is stored in the buffer as is, and the operation is performed while reading from the buffer to the destination location. However, the same principle can be used in order to perform the operation while writing to the buffer, and reading the information from the buffer as is.

It will be appreciated that in order to generate a 180° rotation, the four bottom right pixels, taking up the four rightmost addresses of the bottom line of the buffer should be copied to the four left pixels of the top line of the destination and take up the four leftmost addresses there, the fifth to eight pixels from the right of the bottom line should be copied to the fifth to eight pixels from the left of line 220, and so on. However, since each 32 bits sequence represents four pixels, it is required to reverse the byte order within the read sequence when copying from the source to the destination.

Thus, when reading the data from the buffer in order to write it to the destination location at the DRAM as rotated, the four pixels surrounded by ellipse 1120 are read and written to location 1120′, wherein the order of the bytes is reversed.

Next, the four pixels surrounded by ellipse 1124 is read and written to location 1124′ with reversed bytes, and so on

Once all pixels of the top line of the destination are written, the pixels of the second line from the bottom are read and written into second line of the destination. Thus, in order to fill the destination from left to right and from top to bottom, the buffer is read right to left and bottom to top.

It will be appreciated that the same multiplexing schemes shown for 90° rotations, are also valid for 180° rotation. However, the order of the bytes output by the multiplexers, when rotating 8 bpp and 16 bpp images, may have to be changed, as detailed in association with FIG. 10 and FIG. 11 above.

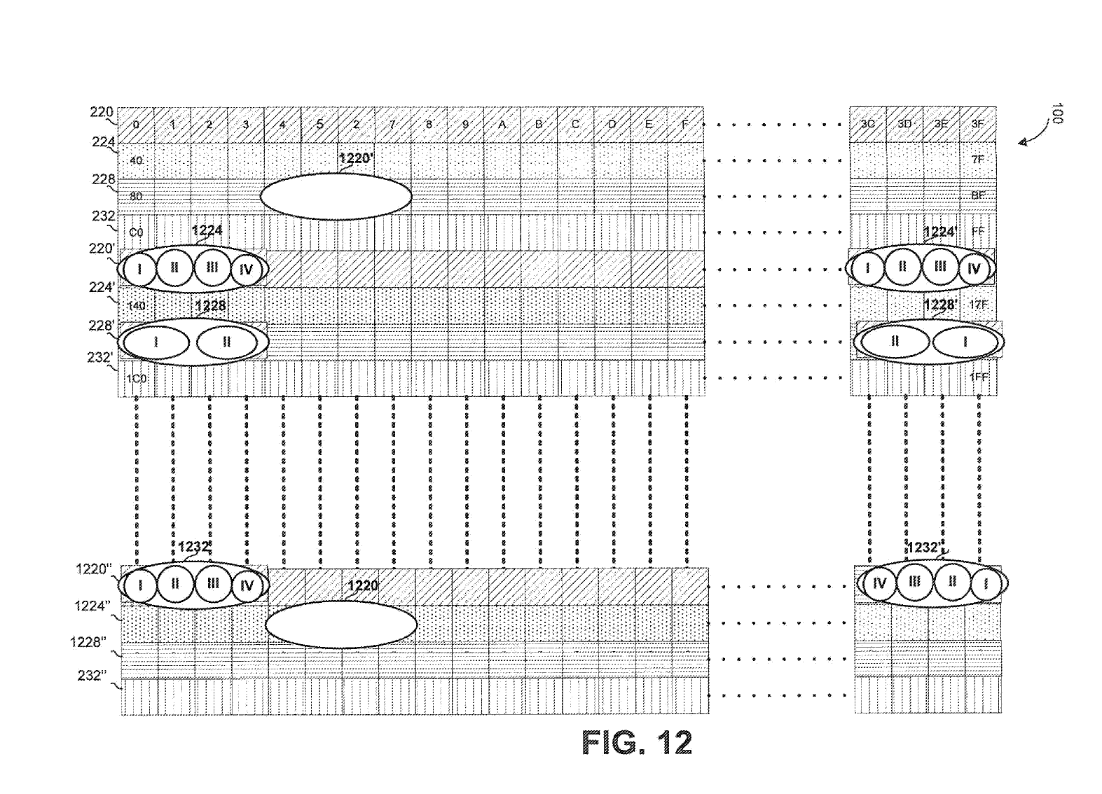

Referring now to FIG. 12 showing a schematic illustration of the flip operations.

As for determining the location of a source block within the destination location, the coordinates are determined as follows:

For vertical flip, i.e. flipping around a horizontal axis; the buffer is read in lines, and the destination is written in the symmetrical lines. Thus, a 32-bit block read at bytes [X, Y] . . . [X+3, Y] of the buffer, is written to bytes [X, N−Y] . . . [X+3, N−Y] of the destination, wherein N is the number of lines in the buffer, which depends on the image bpp resolution. Since each line retains the same byte order, the byte order is unchanged for all resolutions. Thus, no matter what the image resolution is, the bytes of ellipse 1220 are copied to location 1220′ in the destination as is.

The location of each block of the source image within the destination image is determined as follows:

Xdestination=Xsource

Ydestination=(image_height/block_height)−Ysource−1,

Wherein Xsource and Ysource are the X and Y coordinates of the block within the source image, and Xdestination and Ydestination are the coordinates of the block to which the source block is transferred in the flipped image.

For horizontal flip, i.e., flipping around a vertical axis, each 32-bit block read at bytes [X, Y], is written to coordinates [60-X, Y] at the destination. However, as for the byte order, three cases are differentiated.

For images having resolution of 32 bpp, each copied sequence comprises a single pixel, and no byte order changing is required. Thus, the pixel at bytes [X, Y] . . . [X+3, Y], is written to coordinates [60−X, Y] . . . [63−X, Y] at the destination location. For example, the pixel indicated by ellipse 1224 is copied to ellipse 1224′ as is.

For images having resolution of 16 bpp, each copied sequence comprises two pixels, which should be reversed when horizontally flipping. Thus, the two pixels surrounded by ellipse 1228 are copied to ellipse 1228′, but should be reversed, so that bits [15:0] become bits [31:16], and vice versa.

For images having resolution of 8 bpp, each copied sequence comprises four pixels, which should be reversed when horizontally flipping. Thus, the four pixels indicated by ellipse 1232 are copied to ellipse 1232′, but should be reversed, so that bits [7:0] become bits [31:24], bits [15:8] become bits [23:16] bits [23:16] become bits [15:8] and bits [31:24] become bits [7:0].

It will be appreciated that changing the byte order as required for 16 bpp and 8 bpp images is performed by changing the order of the bytes output by the multiplexers, as detailed in association with FIG. 10 and FIG. 11 above. However, the multiple outputs of the multiplexers are selected for further pixels on further columns of the same line rather than pixels of the same column of different lines as in rotating images in 90°.

The location of each block of the source image within the destination image is determined as follows:

Xdestination=(image_width/block_height)−Xsource−1,

Ydestination=Ysource

Wherein Xsource and Ysource are the X and Y coordinates of the block within the source image, and Xdestination and Ydestination are the coordinates of the block to which the source block is transferred in the destination image.

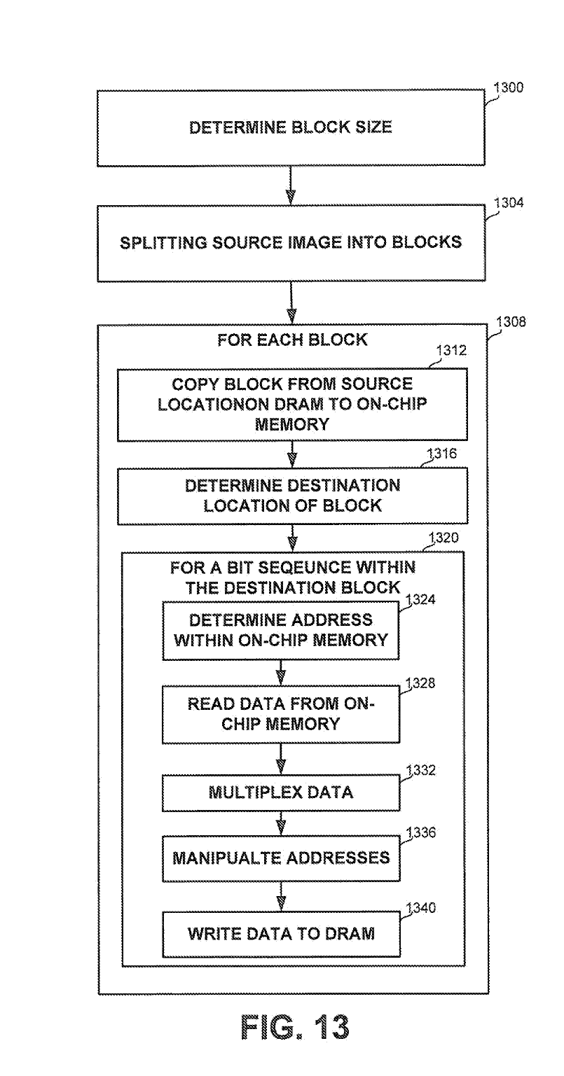

Referring now to FIG. 13, showing a flowchart of the main steps in a method for manipulating images. The method manipulates, for examples flips or rotates a source image in the DRAM and generates a destination image in the DRAM.

On step 1300, a block size is determined in accordance with the buffer size, which may be 4 KB, and in accordance with parameters such as the given image bpp resolution.

On optional step 1304, the image is split into blocks arranged in lines and columns, in accordance with the image size and the block size.

Steps 1308 described below are performed for manipulating each of the source image blocks.

On step 1312 the contents of the block is copied from the source DRAM to an on-chip memory buffer, the memory buffer comprising a predetermined number of memory elements accessed as a rectangle which may have a 64 bytes width.

On step 1316 the destination block location for the block within the destination location in the DRAM is determined.

Steps 1320 are performed for address sequences within the destination block covering the whole block. The address sequence can comprise 32 bit arranged in one line, comprising a variable number of pixels, the number of pixels depending on the image resolution.

On step 1324 the relevant addresses within the on-chip buffer, in which pixels at the required location within the destination are to be found are determined.

On step 1328 the data is read from the on-chip memory from the addresses determined on step 1324.

On step 1332 the data is multiplexed to select the relevant pixels. On step 1336 the byte order within the data is manipulated if required, and on step 1340 the data is written at the corresponding location of the destination location within the DRAM.

It will be appreciated that the detailed method can be enhanced so that the address manipulation will be performed upon reading the block from the source DRAM and writing on the on-chip buffers, rather than when moving the block back from the on-chip memory to the destination address within the DRAM.

In this case, the operations are performed as follows: first, a block size is determined in accordance with a characteristic of the image, and the source image is split into blocks. Each block is manipulated as follows: a destination block location is determined for the block. For each address sequence within the destination block location, one or more addresses are determined within the source image, which contain pixels to be written at the address sequence within the destination block location; information is copied from the source location to an on-chip memory buffer, comprising a predetermined number of memory elements arranged as a rectangle which may have a 64 bytes width, in a location corresponding to the address sequence; data is read from the on-chip memory buffer; and written in the address sequence within the destination block location.

It will also be appreciated that a second buffer can be added to the on-chip memory, which can eliminate the need to separate source and destination locations within the DRAM, and enable on-the-spot manipulation. With such configuration, if block A is to be moved to block B, block B is to be moved to block C, and so on, the following sequence can take place: block A will be copied to a first buffer. Then block A will be manipulated and written to the destination location, but prior to that the block at that destination location will be copied to the second buffer. The block at the second buffer will be manipulated, and before being written to its destination location, the block at that location will be copied to the first buffer, and so on.

It will also be appreciated that images that are made of multiple layers, such as RGB images that comprise separate red, green and blue layers can be handled using the disclosed integrated circuit and method, by using the integrated circuit and applying the method to each layer separately and combining the results as usual.

It will be appreciated that the detailed method covers also an apparatus for carrying out the method in which every step is performed by a relevant component, and also a computer storage device comprising computer instructions for carrying so out the method.

It will be appreciated that the disclosed subject matter can also be associated with an application processor or a video processor having embedded DRAM, since the restriction related to DRAM random access applies for such configurations as well.

It will be appreciated that the disclosed subject matter can also be associated with a storage device comprising computer instructions for performing the disclosed methods.

It will be appreciated that the disclosed apparatus, method and device are exemplary only and that further embodiments can be designed according to the same guidelines and concepts. Thus, different, additional or fewer components or steps can be used, different features can be used, different configurations can be applied, or the like.

It will be appreciated by persons skilled in the art that the present disclosure is not limited to what has been particularly shown and described hereinabove. Rather the scope of the present disclosure is defined only by the claims which follow.

1. A method for manipulating an image stored in a source location and obtaining a manipulated image in a destination location, comprising:
determining a block size in accordance with a characteristic of the image; and
for each block within the source image, manipulating the block, comprising:
copying the block from the source location to an on-chip memory buffer, comprising a predetermined number of memory elements arranged as a rectangle having a rectangle width in bytes being a multiple of 4 times an integer number equal to or larger than one;
determining a destination block location for the block; and
for an address sequence within the destination block location, performing:
determining at least one address within the memory buffer which contain pixels to be written at the address sequence within the destination block location;
reading data from the at least one address within the memory buffer; and
writing the data in the address sequence within the destination block.

2. The method of claim 1 further comprising multiplexing the data read from the one or more addresses within the memory buffer.

3. The method of claim 1 further comprising changing byte order within the data read from the at least one address within the memory buffer.

4. The method of claim 1 wherein the manipulation is flipping or rotating.

5. The method of claim 1 wherein the on-chip memory buffer comprises four memory elements of four times the integer number squared bytes each.

6. The method of claim 1 wherein the number of lines in the block is determined as the rectangle width divided by the number of bytes per pixel in the image.

7. The method of claim 1 wherein the block width is 64 bytes.

8. The method of claim 1 wherein the on-chip memory buffer comprises four memory elements of one kilo byte each.

9. A method for manipulating an image stored in a source location and obtaining a manipulated image in a destination location, comprising:
determining a block size in accordance with a characteristic of the image;
for each block within the image, manipulating the block, comprising:
determining a destination block location for the block;
for an address sequence within the destination block location, performing:
determining at least one addresses within the source image which contain pixels to be written at the address sequence within the destination block location;
copying information from the source location to an on-chip memory buffer, comprising a predetermined number of memory elements arranged as a rectangle having a width being a multiple of four times an integer number equal to or larger than one, in a location corresponding to the address sequence;
reading data from the on-chip memory buffer; and
writing the data in the address sequence within the destination block location.

10. An integrated circuit for manipulating an image stored in a source location on a dynamic random access memory (DRAM) for obtaining a manipulated image in a destination location on the DRAM, comprising:
on-chip memory buffers comprising a predetermined number of memory elements, the on-chip memory buffer adapted to comprise a block of data from the image;
an address generator for determining one or more addresses within the on-chip memory buffer which contain pixels to be written at an address sequence within a destination location for the block of data;
a controller for controlling the operation and data flow within the integrated circuit and between the integrated circuit and the DRAM; and
a bus for transferring data between the integrated circuit and the DRAM.

11. The integrated circuit of claim 10 further comprising at least one multiplexer for multiplexing data read from the on-chip memory buffer.

12. The integrated circuit of claim 10 wherein the manipulation is flipping or rotating.

13. The integrated circuit of claim 10 wherein the on-chip memory buffer comprises a predetermined number of memory elements, arranged as four memory banks.

14. The integrated circuit of claim 10 wherein the on-chip memory buffer comprises a predetermined number of memory elements, each having a size in bytes of four times an integer number squared.

15. The integrated circuit of claim 14 wherein the block has a width in bytes of a multiple of four by the integer number, and the block has a number of lines determined as the block width in bits divided by the number of bits per pixel in the image.

16. The integrated circuit of claim 14 wherein the on-chip memory buffer comprises four memory elements having a size in bytes of four times the integer number squared each.

17. The integrated circuit of claim 10 wherein the block width is 64 bytes.
